(19) United States
(12) Patent Application Publication
(10) Pub. No.: US 2023/0055744 A1
(43) Pub. Date: Feb. 23, 2023

(54) SYSTEM AND METHOD FOR DISPATCHING MOBILITY

(71) Applicants: Hyundai Motor Company, Seoul (KR); Kia Corporation, Seoul (KR)

(72) Inventor: Byoung Suk AHN, Gwacheon-Si (KR)

(73) Assignees: Hyundai Motor Company, Seoul (KR); Kia Corporation, Seoul (KR)

(21) Appl. No.: 17/840,318

(22) Filed: Jun. 14, 2022

(30) Foreign Application Priority Data
Aug. 23, 2021 (KR) 10-2021-0110656

(51) Int. Cl. G01C 21/34; G09B 21/00

(52) U.S. Cl. CPC G01C 21/3438; G01C 21/3484; G09B 21/00

(57) ABSTRACT

A user can identify the mobility dispatched to the user by changing the color of the mobility when the user utilizes a service using the mobility. Furthermore, even when the visually impaired person utilizes the mobility, a guide dog can guide the visually impaired person to the mobility through the generation of a sound that the guide dog can recognize, as well as the color, so that the visually impaired person can use the mobility conveniently.

### CROSS REFERENCE TO RELATED APPLICATION

The present application claims priority to Korean Patent Application No. 10-2021-0110656, filed Aug. 23, 2021, the entire contents of which is incorporated herein for all purposes by this reference.

### BACKGROUND OF THE PRESENT DISCLOSURE

### Field of the Present Disclosure

The present disclosure relates to a system and method for dispatching mobility in which a user can easily identify a dispatched mobility when using a service using mobility to improve usability.

### Description of Related Art

Recently, with the development of information and communication technology, the popularization of communication terminals (mobile devices) is rapidly accelerating, and most people now always carry smart devices such as cell phones, smart phones, and the like. Therefore, a user can easily communicate with each other using the smart device, and communication has become more frequent than before through various applications, and the number of users of the smart device is gradually increasing.

Accordingly, it is possible to provide a mobility service using a smart device.

When using the mobility service, the mobility approaches the user, and pickup are performed, but there is a problem in that it is difficult for the user to identify the mobility.

That is, a message indicating that the mobility is approaching is transmitted through the smart device so that the user can identify the mobility, but there is a limitation in finding the dispatched mobility unless the mobility is identified with the naked eye of the user.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system and method for dispatching mobility in which a user can easily identify a dispatched mobility when using a service using mobility to improve usability.

In various aspects of the present disclosure, the system for dispatching mobility includes communication device that is configured to transmit a request for dispatch of the mobility according to a user's request; a message display device which is provided in the mobility and is configured to display color to outside through color change to transmit a message; and a server that is configured to receive information on the dispatch of the mobility according to the user's request determines the color so that the mobility dispatched to the user is identified, and transmits a signal so that the determined color is displayed on the message display device.

When determining the color, the server is configured to determine a different color if the same color exists according to another user's request for dispatch of the mobility within a predetermined distance from the user

When determining the color, the server is configured to determine the color by crossing colors in an order of which the difference in color is greater in a pre-stored color table.

When the server concludes that the user determines the color through the communication device, the server is configured to transmit the signal so that the color is determined by the user is displayed on the message display device.

The server is configured to identify the color determined by another user's request for dispatch of the mobility within a predetermined distance from the user who requests the dispatch of the mobility, and provides the user's communication device with a list of colors in which the color determined by the other user is excluded.

The message display device includes a display device to display a character or a symbol, the communication device is configured to transmit and authenticate registered ID information to the server for authentication when the user requests the dispatch of the mobility, and the server is configured to display the character or the symbol preset by the user on the display device when the authentication of the ID information is verified.

The display device is configured so that a background color and the color of the character or the symbol are changed, and when the server concludes that the user requests the dispatch of the mobility, the server is configured to determine the background color and the color of the character or the symbol differently and transmits each determined color to the display device.

When the server concludes that the user requests the dispatch of the mobility, the server is configured to determine the background color and the color of the character or the symbol with opposite colors from a pre-stored complementary color contrast table

The message display device includes a sound generator that is configured to generate a sound, and is configured to convert a frequency band of the sound, and the server is configured to send a command to the sound generator to generate the sound when the user is a visually impaired person and the dispatch of the mobility is requested from the communication device of the visually impaired person.

When the dispatch of the mobility is requested from the communication device of the visually impaired person, the server causes the sound generator to generate the sound in the frequency band that only a guide dog accompanying the visually impaired person hears.

When the server concludes that another visually impaired person requests the dispatch of the mobility within a predetermined distance from the visually impaired person who requests the dispatch of the mobility, the server is configured to transmit a wait message through the communication device of each visually impaired person until the mobility arrives.

On the other hand, the method for dispatching a mobility according to an exemplary embodiment of the present disclosure includes a request confirmation step of confirming a user's request for dispatch of the mobility through a communication device; a determination step of determining a color so that the mobility dispatched to the user is identified; and a command step of displaying the determined color on a message display device provided in the mobility.

The determination step further includes a correction step of confirming another user's request for the dispatch of the mobility within a predetermined distance from the user when determining the color, and determining a different color if the color determined by the other user is the same color.

The correction step determines the color by crossing colors in an order of the largest color difference in a color table when determining the color.

In the determining step, a signal is transmitted so that the color determined by the user is displayed on the message display device in a response that the user determines the color through the communication device.

In the correction step, the color determined by another user's request for the dispatch of the mobility within a predetermined distance from the user who requests the dispatch of the mobility is identified, and the user's communication device is provided with a list of colors in which the color is determined by the other user is excluded.

In the request confirmation step, authentication of registered ID information is performed when the user requests the dispatch of the mobility, and in the determination step, a character or a symbol preset by the user is displayed on a display device provided in the mobility when the authentication of the ID information is verified in the request confirmation step.

In the determination step, a background color and the color of the character or the symbol are determined differently when the user requests the dispatch of the mobility.

In the determination step, the background color and the color of the character or the symbol are determined with opposite colors from a pre-stored complementary color contrast table when the user requests for mobility dispatch.

The request confirmation step further includes confirming whether it is the request for the dispatch of mobility from the communication device of a visually impaired person, and the command step includes generating a sound of a set frequency band through a sound generator provided in the mobility when it is confirmed that the request for the dispatch of the mobility is from the communication device of the visually impaired person in the request confirmation step.

The request confirmation step includes identifying whether there is the request for the dispatch of the mobility by another visually impaired person within a predetermined distance from the visually impaired person who requests the dispatch of the mobility, and the command step includes transmitting a wait message through the communication device of each visually impaired person until the mobility arrives when there is the request for the dispatch of the mobility by the other visually impaired person.

The system and method for dispatching a mobility configured as described above allow a user to identify the mobility dispatched to the user by changing the color of the mobility when the user utilizes a service using the mobility. Furthermore, even when the visually impaired person utilizes the mobility, a guide dog can guide the visually impaired person to the mobility through the generation of a sound that the guide dog can recognize, as well as the color, so that the visually impaired person can use the mobility conveniently.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic diagram of a system for dispatching a mobility according to an exemplary embodiment of the present disclosure.

FIG. 2 is a diagram showing a color table.

FIG. 3 is a diagram for explaining a display device.

FIG. 4 is a diagram illustrating a complementary color contrast table.

FIG. 5 and FIG. 6 are flowcharts of a method for dispatching a mobility according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a system and method for dispatching mobility according to various exemplary embodiments of the present disclosure will be described with reference to the accompanying drawings.

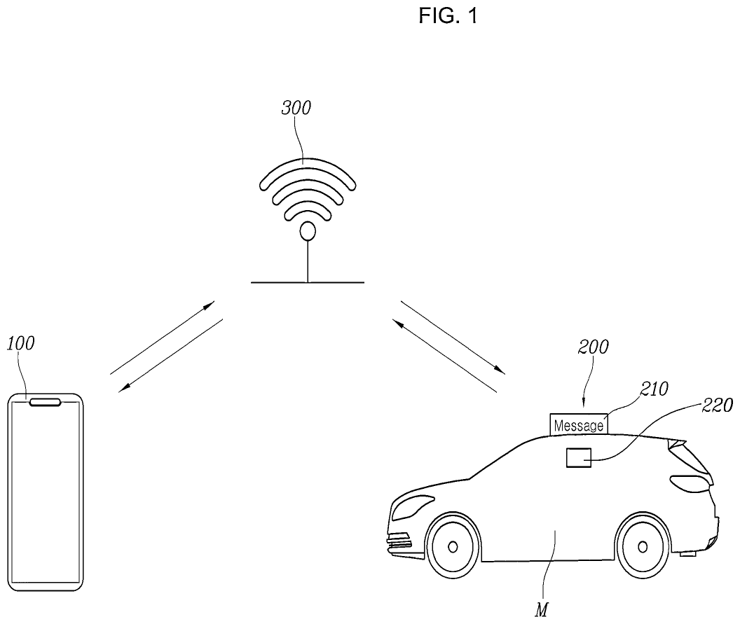

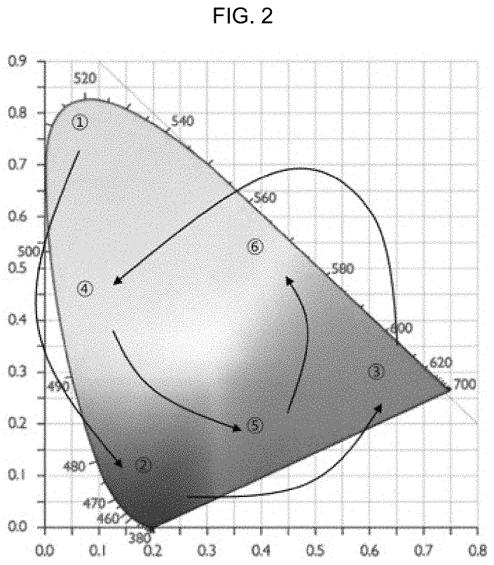

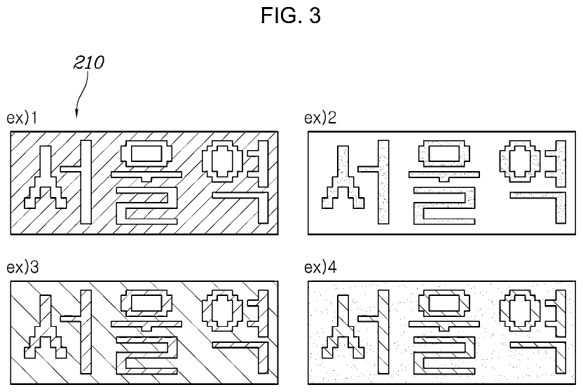

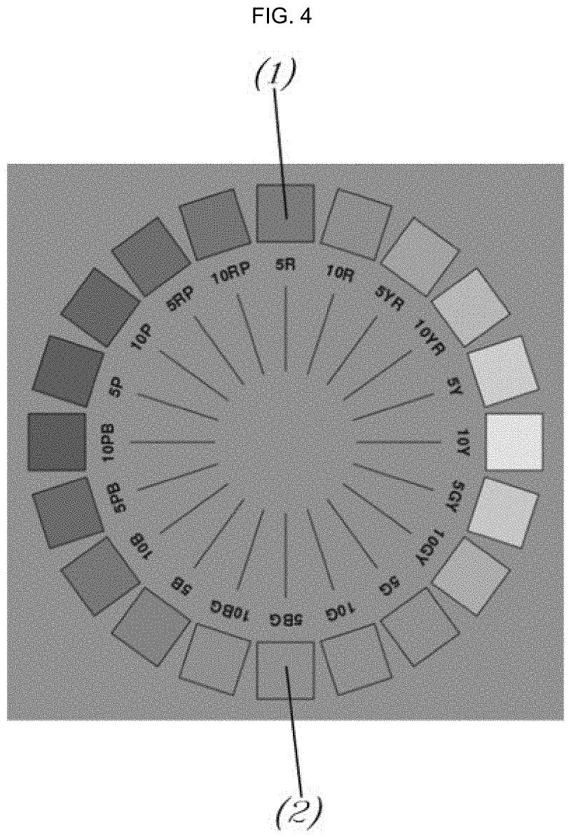

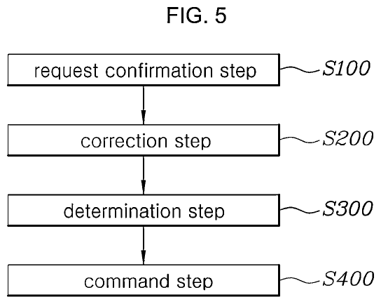

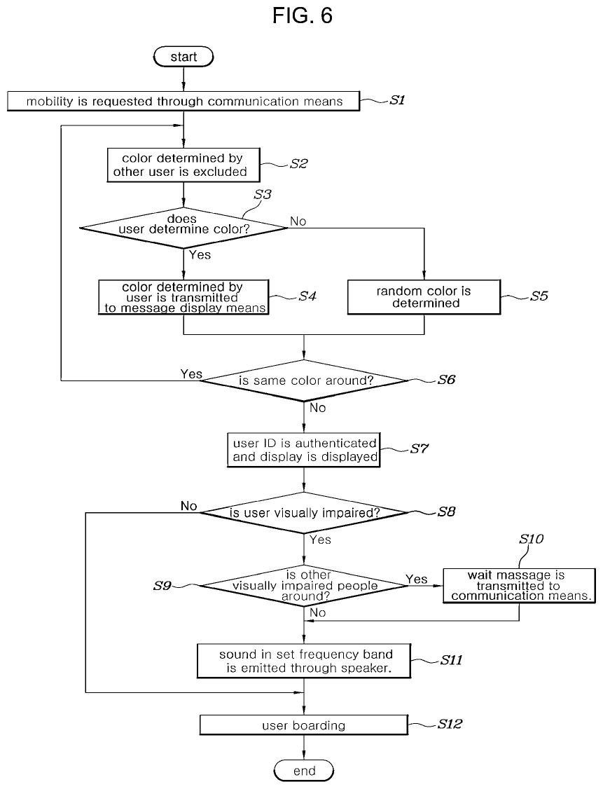

FIG. 1 is a schematic diagram of a system for dispatching mobility according to an exemplary embodiment of the present disclosure, FIG. 2 is a diagram showing a color table, FIG. 3 is a diagram for explaining a display device, FIG. 4 is a diagram illustrating a complementary color contrast table, and FIG. 5 and FIG. 6 are flowcharts of a method for dispatching mobility according to an exemplary embodiment of the present disclosure.

As shown in FIG. 1, the system for dispatching mobility according to an exemplary embodiment of the present disclosure includes a communication device 100 that transmits a request for dispatch of mobility (M) according to a user's request; a message display device 200 which is provided in the mobility (M) and displays color to outside through color change to transmit a message; and a server 300 that receives information on the dispatch of the mobility (M) according to the user's request, determines the color so that the mobility (M) dispatched to the user is identified, but determines a different color if the same color exists according to another user's request for the dispatch of the mobility (M) within a certain distance from the user, and transmits a signal so that the determined color is displayed on the message display device 200.

Here, the mobility (M) is a vehicle of moving to a specific destination by driving directly by a driver, or a vehicle of moving to a specific destination through satellite communication when fully autonomous driving is possible.

The communication device 100 includes a communication terminal (mobile device) carried by the user, and the user may request dispatch of the mobility (M) through the communication device 100.

The message display device 200 is provided in the mobility (M), and is configured to display color to an outside through color change. The message display device 200 may include a light-emitting diode (LED) and a light guide, and may be applied in various ways by emitting light. Furthermore, the message display device 200 is provided on the upper side of the mobility (M) so that the user can easily recognize the color displayed on the message display device 200.

Through this, in an exemplary embodiment of the present disclosure, when the user requests the dispatch of the mobility (M) using the communication device 100, the server 300 identifies the location of the user and the location of the mobility (M) around the user, and dispatches the mobility (M) which may be moved to the user in the shortest time.

Furthermore, the server 300 determines the color of the mobility (M) dispatched to the user. Accordingly, when the mobility (M) moves to the user, the user identifies the mobility (M) dispatched to the user through the color displayed on the message display device 200 provided in the mobility (M), securing the convenience of use.

However, when determining color, the server 300 determines a different color when the same color exists according to another user's request for the dispatch of the mobility (M) within a certain distance from the user, avoiding confusion due to the mobility (M) displaying the same color.

That is, the mobility (M) moved to each user prevents the color displayed on the message display device 200 from overlapping within a certain distance from each user, so that the user can clearly identify the mobility (M) dispatched to himself by color when using the mobility (M), improving the convenience of use of the mobility (M).

The color of each mobility (M) dispatched from the server 300 may be implemented as follows.

In an exemplary embodiment of the present disclosure, when determining color, the server 300 determines the color by crossing the colors in an order of the largest color difference in the pre-stored color table.

That is, when the user requests the dispatch of the mobility (M) through the communication device 100, the server 300 determines the color to be displayed on the message display device 200 of the dispatched mobility (M). In the instant case, the server 300 determines the color by crossing colors in an order of which the difference in color is greater in the pre-stored color table, increasing the color difference to prevent confusion due to similar colors.

As can be seen in FIG. 2, a color table is pre-stored in the server 300, and when color is determined with respect to a plurality of mobility (M), color of a Green (\textcircled{1}) series is first determined, and then color of a Blue (\textcircled{2}) series is determined, and then the color of the Red (\textcircled{3}) series is determined, and then in an order of \textcircled{4}, \textcircled{5}, and \textcircled{6}, each color can be determined so as not to overlap with each other in an order of the greatest color difference.

Accordingly, even if the mobility (M) is concentrated in a specific area, the user can recognize the color displayed on the message display device 200 of the dispatched mobility (M), and use the dispatched mobility (M).

Meanwhile, as another exemplary embodiment of the present disclosure, when the user determines the color through the communication device 100, the server 300 transmits a signal so that the color determined by the user is displayed on the message display device 200.

The color displayed on the message display device 200 of the mobility (M) may be directly determined by the user. When the user directly determines the color through the communication device 100, the server 300 displays the color directly determined by the user on the message display device 200 of the dispatched mobility (M).

Here, the server 300 identifies the color determined by another user's request for the dispatch of the mobility (M) within a certain distance from the user who requests the dispatch of the mobility (M), and provides the user's communication device 100 with a list of colors in which the color determined by the other user is excluded.

That is, when the user requests the dispatch of mobility using the communication device 100 and the same color according to another user's request for the dispatch of the mobility (M) exists within a certain distance from the user, the server is configured to provide the communication device 100 with a list of colors excluding the overlapped color, so that the user avoids determining the overlapped color. Accordingly, when the mobility (M) is dispatched to the user, the confusion due to the mobility (M) displaying the same color is prevented from occurring.

In the present way, the user determines the color when requesting the dispatch of the mobility (M) through the communication device 100, but as the determination of the overlapped color is avoided in the vicinity, the mobility (M) displaying the overlapped color does not exist. Thus, the mobility (M) dispatched to the user is clearly distinguished by color in using the mobility (M) so that the convenience of use of the mobility (M) is improved.

Meanwhile, the message display device 200 may further include a display device 210 to display a character or a symbol. That is, by displaying the character or symbol through the display device 210 in addition to the color display through the message display device 200, the user can more conveniently recognize the dispatched mobility (M).

That is, the communication device 100 transmits registered ID information to the server 300 for authentication when the user requests the dispatch of the mobility (M). That is, when the user requests the dispatch of the mobility (M), the registered ID is transmitted to the server 300, and the server 300 performs the user's authentication procedure according to the corresponding ID, confirming the security element.

In the present way, when the authentication of the ID information is verified in the server 300, the server 300 transmits a command signal to the display device 210 to display the character or symbol preset by the user. That is, the character or symbol preset by the user is displayed through the display device 210, so that the user can easily identify the mobility (M) dispatched to the user.

Furthermore, various information such as whether the mobility (M) is operated and a destination may be provided to the outside through the display device 210.

Furthermore, the display device 210 is configured so that background color and the color of the character or the symbol may be changed, and the server 300 determines the background color and the color of the character or the symbol differently when the user requests the dispatch of the mobility (M), and transmits each determined color to the display device 210.

Accordingly, as shown in FIG. 3, the display device 210 is configured to display the background color and the color of the character or the symbol differently, so that the user can easily recognize the message by the display device 210 through color contrast due to the background color and the color of the text or symbol being different from each other.

Accordingly, when the user requests the dispatch of the mobility (M), the server 300 determines the background color and the color of a character or a symbol to be different from each other and transmits each determined color to the display device 210. That is, the server 300 determines the background color and the color of the character or the symbol displayed on the display device 210 to be different from each other when the user requests the dispatch of mobility through the communication device 100, so that the message of the message display device 200 is easily identified through the contrast between the background color and the color of the character or symbol. Furthermore, the server 300 transmits the color and the message to be displayed on the display device 210 in advance through the user's communication device 100, so that the user can recognize the mobility (M) dispatched to himself

The server 300 may determine the background color and the color of the character or the symbol to be opposite to each other in a pre-stored complementary color contrast table when the user requests the dispatch of the mobility (M).

That is, the server 300 determines the color of the background and the color of the character or the symbol to be displayed on the display device 210 of the dispatched mobility (M) when the user requests the dispatch of the mobility (M) through the communication device 100. In the instant case, the server 300 determines the background color and the color of the character or the symbol to be opposite to each other so that the color contrast is large in the pre-stored complementary color contrast table, increasing the color contrast so that the character or symbol is clearly recognized.

As may be seen in FIG. 4, a complementary color contrast table is pre-stored in the server 300, and when the background color is determined as the color of (1), the color of the character or the symbol is determined as the color of (2), so that the user can clearly recognize the character or symbol. Furthermore, the user can easily find the dispatched mobility (M) by recognizing the color displayed on the display device 210.

Meanwhile, the message display device 200 may be further including a sound generator 220 that generates a sound, and is configured to convert the frequency band of the sound. That is, by generating a sound through the sound generator 220 in addition to the color display through the message display device 200, the user can find the mobility

(M).

This may be used when the user is visually impaired person. Of course, in the case of the general public in addition to the visually impaired person, it is possible to recognize the mobility (M) through the sound of the sound generator 220. However, because an unpleasant feeling may be generated by sound generation to other people in the vicinity, only for the visually impaired person, the user recognizes the mobility (M) through the sound generation of the sound generator 220.

Accordingly, the server 300 transmits a command to the sound generator 220 so that a sound is generated when the user is a visually impaired person and the dispatch of the mobility (M) is requested from the communication device 100 of the visually impaired person. Accordingly, the visually impaired person can use the mobility (M) by recognizing the sound generated from the speaker of the mobility (M).

Furthermore, when the dispatch of the mobility (M) is requested from the communication device 100 of the visually impaired person, the server 300 causes the sound generator 220 to generate a sound in a frequency band that can only be heard by a guide dog accompanying the visually impaired person.

That is, when the dispatch of the mobility (M) is requested from the communication device 100 of the visually impaired person, the server 300 generates a sound of a specific frequency band that only the guide dog can hear through the sound generator 220. The frequency band of these sounds may be greater than or equal to 20,000 Hz, and humans cannot recognize it, and only the guide dog accompanying the visually impaired person can hear the sound generated by the sound generator 220, so that the guide dog can guide the visually impaired person to the mobility (M).

Thus, it prevents the unpleasant feeling of the surrounding people as the sound is generated by the sound generator 220 provided in the mobility (M), and the guide dog recognizes the sound generated by the mobility (M) to guide the visually impaired person to the mobility (M). Accordingly, even the visually impaired person can use Mobility (M) stably and conveniently.

On the other hand, when another visually impaired person requests the dispatch of the mobility (M) within a certain distance from the visually impaired person who requests the dispatch of the mobility (M), the server 300 transmits a wait message through the communication device 100 of each visually impaired person until the mobility (M) arrives.

In the present way, when another visually impaired person requests the dispatch of the mobility (M) within a certain distance from the visually impaired person who requests the dispatch of the mobility (M), the wait message is transmitted to the communication device 100 of the visually impaired person carried by the visually impaired person until the mobility (M) arrives, so that the visually impaired person does not get confused according to another mobility (M). In the instant case, a vibration or a voice message may be transmitted to the communication device 100 of the visually impaired person.

Thus, the visually impaired person requests the dispatch of the mobility (M), and upon arrival of the mobility (M), even if the guide dog confuses it with mobility (M) other than the mobility (M) dispatched to the visually impaired person, the visually impaired person can find and use the mobility (M) dispatched to himself by checking whether the mobility (M) dispatched to himself has arrived through the communication device 100.

On the other hand, the method for mobility (M) dispatch according to an exemplary embodiment of the present disclosure, as shown in FIG. 5, includes the request confirmation step of a user's request for dispatch of the mobility (M) through the communication device 100 (S100); a correction step (S200) of confirming another user's request for the dispatch of the mobility (M) within a certain distance from the user, and determining a different color if the color determined by the other user is the same color; a determination step (S300) of determining color so that the mobility (M) dispatched to the user is identified; and a command step (S400) of displaying the determined color on the message display device 200 provided in the mobility (M).

In the present way, the present disclosure determines the color of the mobility (M) dispatched to the user, and when the mobility (M) moves to the user, the user identifies the mobility (M) dispatched to himself through the color displayed on the message display device 200 provided in the mobility (M), so that the convenience of use is secured.

Furthermore, in an exemplary embodiment of the present disclosure, a different color is determined in determining color when the same color exists according to another user's request for the dispatch of the mobility (M) within a certain distance from the user. Accordingly, the confusion due to the mobility (M) displaying the same color may be avoided.

On the other hand, in the correction step (S200), when determining the color, the color is determined by crossing the colors in an order of the largest color difference in the color table.

That is, in the correction step, when determining the color, the colors are determined by crossing them in an order of the largest color difference in the pre-stored color table, increasing the color difference to prevent confusion due to similar colors.

In another exemplary embodiment of the present disclosure, in the determination step (S300), when the user determines the color through the communication device 100, a signal is transmitted so that the color determined by the user is displayed on the message display device 200.

Furthermore, the correction step (S200) identifies the color determined by another user requesting the dispatch of the mobility (M) within a certain distance from the user who requests the dispatch of the mobility (M), and provides the user's communication device 100 with a list of colors in which the color determined by the other user is excluded.

That is, the color displayed on the message display device 200 of the mobility (M) may be directly determined by the user, and when the user directly determines the color through the communication device 100, the color directly determined by the user is displayed on the message display device 200 of the dispatched mobility (M).

Furthermore, in the correction step (S200), if the same color according to another user's request for the dispatch of the mobility (M) exists within a certain distance from the corresponding user, the communication device 100 is provided with a list of colors in which the overlapped color is excluded, so that the determination of the overlapped color is avoided. Accordingly, when the mobility (M) is dispatched to the user, the confusion due to the mobility (M) displaying the same color is prevented from occurrence.

On the other hand, the request confirmation step (S100) performs the authentication of registered ID information when the user requests the dispatch of the mobility (M), and the character or symbol preset by the user is displayed on the display device 210 provided in the mobility (M) in the command step (S400) when the authentication of the ID information is verified in the request confirmation step (S100).

In the present way, when the authentication of the ID information is verified through the request confirmation step (S100), the command step (S400) transmits a command signal to the display device 210 so that the character or a symbol preset by the user is displayed. Accordingly, it is easy for the user to identify the mobility (M) dispatched to the user by checking the user's preset character or symbol displayed through the display device 210.

Meanwhile, in the determination step (S300), the background color and the color of the character or the symbol are determined to be different from each other when the user requests the dispatch of the mobility (M), so that the background color and the character or symbol are displayed in each determined color.

Here, in the determination step (S300), when the user requests the dispatch of the mobility (M), the background color and the color of the character or the symbol are displayed as opposite colors from the complementary color contrast table.

Accordingly, in the determination step (S300), by determining the background color and the color of the character or the symbol differently, it is easy for the user to recognize the message through the display device by the color contrast due to the difference between the background color and the color of the character or symbol.

Also, in the determination step (S300), the background color and the color of the character or the symbol are determined with opposite colors so that the color contrast is large in the pre-stored complementary color contrast table, increasing the color contrast so that the character or symbol is clearly recognized.

On the other hand, in the request confirmation step (S100), it is further confirmed whether it is the request for the dispatch of the mobility (M) from the communication device 100 of the visually impaired person. When it is confirmed that it is the request for the dispatch of the mobility (M) from the communication device 100 of the visually impaired person in the request confirmation step (S100), a sound of a set frequency band is generated through the sound generator 220 provided in the mobility (M) in the command step (S400).

That is, when the dispatch of the mobility (M) is requested from the communication device 100 of the visually impaired person in the request confirmation step (S100), a specific frequency band in which only the guide dog can hear is generated through the sound generator 220 in the command step (S400). The frequency band of these sounds may be greater than or equal to 20,000 Hz, and humans cannot recognize it and only the guide dog accompanying the visually impaired person can hear the sound generated by the sound generator 220, so that the guide dog can guide the visually impaired person to the mobility (M).

Accordingly, it prevents the unpleasant feeling of the surrounding people as the sound is generated by the sound generator 220 provided in the mobility (M), and the guide dog recognizes the sound generated by the mobility (M) to guide the visually impaired person to the mobility (M). Thus, even the visually impaired person can use the mobility (M) stably and conveniently.

Furthermore, in the request confirmation step (S100), it is confirmed whether there is the request for dispatch of the mobility (M) by another visually impaired person within a certain distance from the visually impaired person who requests the dispatch of the mobility (M), and when there is the request for dispatch of the mobility (M) by another visually impaired person, a wait message is transmitted through the communication device 100 of each visually impaired person until the mobility (M) arrives in the command step (S400).

Accordingly, when another visually impaired person requests the dispatch of the mobility (M) within a certain distance from the visually impaired person who requests the dispatch of the mobility (M), the wait message is transmitted to the communication device (100) carried by the visually impaired person until the mobility (M) arrives, so that the visually impaired person does not get confused according to other mobility (M). In the instant case, a vibration or a voice message may be transmitted to the communication device 100 of the visually impaired person.

In the present way, the visually impaired person requests the dispatch of the mobility (M) and upon arrival of the mobility (M), even if the guide dog confuses it with the mobility (M) other than the dispatched mobility (M), the visually impaired person may be checked whether the mobility (M) dispatched to himself has arrived through the communication device 100, so that the visually impaired person can find and use the mobility (M) dispatched to himself

The method for dispatching the mobility (M) according to an exemplary embodiment of the present disclosure described above may be performed according to the orders S1 to S12 shown in FIG. 6.

The system and method for dispatching mobility configured as described above allow the user to identify the dispatched mobility by changing the color of the mobility when the user utilizes a service using the mobility. Furthermore, even when the visually impaired person utilizes mobility, the guide dog guides the visually impaired person to the mobility through the generation of the sound that the guide dog can recognize, as well as the color, so that the visually impaired person can use the mobility conveniently.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for dispatching mobility, the system comprising:
a communication device that is configured to transmit a request for dispatch of the mobility according to a user's request;
a message display device which is provided in the mobility and is configured to display color to an outside of the mobility through color change to transmit a message; and
a server that is configured to receive information on the dispatch of the mobility according to the user's request, to determine the color so that the mobility dispatched to the user is identified, and to transmit a signal so that the determined color is displayed on the message display device.

2. The system of claim 1, wherein when determining the color, the server is configured to determine a different color when a same color exists according to another user's request for dispatch of the mobility within a predetermined distance from the user.

3. The system of claim 1, wherein when determining the color, the server is configured to determine the color by crossing colors in an order of a largest color difference in a pre-stored color table.

4. The system of claim 1, wherein when the server concludes that the user determines the color through the communication device, the server is configured to transmit the signal so that the color determined by the user is displayed on the message display device.

5. The system of claim 4, wherein the server is configured to identify the color determined by another user's request for dispatch of the mobility within a predetermined distance from the user who requests the dispatch of the mobility, and to provide the user's communication device with a list of colors in which the color determined by the other user is excluded.

6. The system of claim 1,
wherein the message display device includes a display device to display a character or a symbol,
wherein the communication device is configured to transmit and authenticate registered ID information to the server for authentication when the user requests the dispatch of the mobility, and
wherein the server is configured to display the character or the symbol preset by the user on the display device when the authentication of the ID information is verified.

7. The system of claim 6,
wherein the display device is configured so that a background color and a color of the character or the symbol is changed, and
wherein when the server concludes that the user requests the dispatch of the mobility, the server is configured to determine the background color and the color of the character or the symbol differently and to transmit each determined color to the display device.

8. The system of claim 7, wherein when the server concludes that the user requests the dispatch of the mobility, the server is configured to determine the background color and the color of the character or the symbol with opposite colors from a pre-stored complementary color contrast table.

9. The system of claim 1,
wherein the message display device includes a sound generator that is configured to generate a sound, and is configured to convert a frequency band of the sound, and
wherein the server is configured to send a command to the sound generator to generate the sound when the user is a visually impaired person and the dispatch of the mobility is requested from the communication device of the visually impaired person.

10. The system of claim 9, wherein when the dispatch of the mobility is requested from the communication device of the visually impaired person, the server is configured to cause the sound generator to generate the sound in the frequency band that only a guide dog accompanying the visually impaired person hears.

11. The system of claim 9, wherein when the server concludes that another visually impaired person requests the dispatch of the mobility within a predetermined distance from the visually impaired person who requests the dispatch of the mobility, the server is configured to transmit a wait message through the communication device of each visually impaired person until the mobility arrives.

12. A method for dispatching mobility, the method comprising:
a request confirmation step of confirming a user's request for dispatch of the mobility through a communication device;
a determination step of determining color so that the mobility dispatched to the user is identified; and
a command step of displaying the determined color on a message display device provided in the mobility.

13. The method of claim 12, wherein the determination step includes a correction step of confirming another user's request for the dispatch of the mobility within a predetermined distance from the user when determining the color, and excluding the color determined by the other user.

14. The method of claim 13, wherein in the correction step, the color is determined by crossing colors in an order of a greatest color difference in color table when determining the color.

15. The method of claim 12, wherein in the determining step, a signal is transmitted so that the color determined by the user is displayed on the message display device in a response that the user determines the color through the communication device.

16. The method of claim 15, wherein in the correction step, the color determined by another user's request for the dispatch of the mobility within a predetermined distance from the user who requests the dispatch of the mobility is identified, and the user's communication device is provided with a list of colors in which the color determined by the other user is excluded.

17. The method of claim 12, wherein in the request confirmation step, authentication of registered ID information is performed when the user requests the dispatch of the mobility, and in the determination step, a character or a symbol preset by the user is displayed on a display device provided in the mobility when the authentication of the ID information is verified in the request confirmation step.

18. The method of claim 17, wherein in the determination step, a background color and a color of a character or a symbol are determined differently when the user requests the dispatch of the mobility.

19. The method of claim 18, wherein in the determination step, the background color and the color of the character or the symbol are determined with opposite colors from a pre-stored complementary color contrast table when the user requests for mobility dispatch.

20. The method of claim 12, wherein the request confirmation step further includes confirming whether it is the request for the dispatch of mobility from the communication device of a visually impaired person, and the command step includes generating a sound of a set frequency band through a sound generator provided in the mobility when it is confirmed that the request for the dispatch of the mobility is from the communication device of the visually impaired person in the request confirmation step.

21. The method of claim 20, wherein the request confirmation step further includes identifying whether there is the request for the dispatch of the mobility by another visually impaired person within a predetermined distance from the visually impaired person who requests the dispatch of the mobility, and the command step includes transmitting a wait message through the communication device of each visually impaired person until the mobility arrives when there is the request for the dispatch of the mobility by the other visually impaired person.
